(19) United States
(12) Patent Application Publication
(10) Pub. No.: US 2009/0240982 A1
(43) Pub. Date: Sep. 24, 2009

(54) IMAGE READING APPARATUS, METHOD FOR READING IMAGE, IMAGE FORMING APPARATUS, AND PROGRAM

(75) Inventor: Kenji Ogasawara, Osaka (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/402,882

(22) Filed: Mar. 12, 2009

(30) Foreign Application Priority Data
Mar. 21, 2008 (JP) 2008-073768

(51) Int. Cl. G06F 11/14

(52) U.S. Cl. 714/16; 714/E11.117

(57) ABSTRACT

The image reading apparatus continuously reads image data of a plurality of pages of a document, each page being added with identification information including specific information of the page and common information showing relationship with at least one precedent and one subsequent pages, that includes an image storage potion for storing image data of each page of the read document, an identification information extracting portion for extracting the identification information from the image data, a missing page detecting portion for detecting a page missed by failure of reading in the document based on identification information of each extracted page, and a display portion for prompting reading of the document by displaying the missing page, in which when an instruction of rereading is given and identification information of the missing page is extracted from image data read again, the image data is additionally stored in the image storage portion.

### CROSS-NOTING PARAGRAPH

This non-provisional application claims priority under 35 U.S.C. §119 (a) on Patent Application No. 2008-073768 filed in JAPAN on Mar. 21, 2008, the entire contents of which are hereby incorporated herein by reference.

### FIELD OF THE INVENTION

The present invention relates to an image reading apparatus, a method for reading an image, and an image forming apparatus provided with the image reading apparatus and a program for executing a function of the image reading apparatus.

### BACKGROUND OF THE INVENTION

Today, a copier is capable of performing continuous copying by an automatic document feeder. However, when a plurality of documents are copied continuously, there is a case where two or more documents are fed in the overlapped state (double feeding), which causes missing of copy pages.

In such a case, it is the current situation that a missing page is checked manually, and when a missing page can not be found, it is noticed after distribution, resulting that much labor is required to correspond thereto.

There are an apparatus that detects double feeding based on difference of thickness or length of documents being read, or the like to display an error message, and an apparatus that detects that page numbers added to documents are not a sequence number and displays a list of missing pages (Japanese Laid-Open Patent Publication No. 8-125838 and Japanese Laid-Open Patent Publication No. 2002-139965).

However, in Japanese Laid-Open Patent Publication No. 8-125838 and Japanese Laid-Open Patent Publication No. 2002-139965 described above, missing pages are simply displayed, thus the labor for finding lacking pages is saved but it is necessary to insert missing pages manually, resulting that burden on a user is not reduced.

### SUMMARY OF THE INVENTION

An object of the present invention is to provide an image reading apparatus that reduces a work burden on a user to supplement a missing page when a plurality of sheets of a document are read continuously, a method for reading an image, an image forming apparatus, and a program.

The image reading apparatus and the method for reading an image of the present invention have the following structure. An image reading apparatus that continuously reads image data of a plurality of pages of a document, each page being added with identification information including specific information of the page and common information showing relationship with at least one precedent and one subsequent pages, includes an image storage potion for storing image data of each page of the read document, an identification information extracting portion for extracting the identification information from the image data, a missing page detecting portion for detecting a page missed by failure of reading in the document based on identification information of each extracted page, and a display portion for prompting reading of the document by displaying the missing page, in which when an instruction of rereading is given and identification information of the missing page is extracted from image data read again, the image data is additionally stored in the image storage portion.

Furthermore, a method for reading an image used in an image reading apparatus that continuously reads image data of a plurality of pages of a document, each page being added with identification information including specific information of the page and common information showing relationship with at least one precedent and one subsequent pages, and stores image data of each page of the read document in an image storage portion, includes an identification information extraction step of extracting the identification information from image data of each page of the read document, a missing page detection step of detecting a page missed by failure of reading in the document based on identification information of each extracted page, and a display step of prompting reading of the document by displaying the missing page, in which when an instruction of rereading is given and identification information of the missing page is extracted from image data read again, the image data is additionally stored in the image storage portion.

The identification information preferably includes heading information and a page number, and is formed with code information.

Furthermore, an image forming apparatus may be provided with the above-described image reading apparatus.

Furthermore, a program that causes a computer to function as each portion of the image reading apparatus having the above-described structure is created and the program may be executed by the computer.

### BRIEF DESCRIPTION OF THE DRAWINGS

FIG. 1 is a block diagram showing the schematic structure of an image reading apparatus according to an embodiment of the present invention;

FIG. 2 shows an example of specific information and common information of identification information;

FIG. 3 is a structural view of a document to be read;

FIG. 4 is an external view of a display apparatus of a copier;

FIG. 5 is a block diagram showing the control structure of an image reading apparatus according to an embodiment of the present invention;

FIG. 6 shows the data structure and a data example of a management table storage portion;

FIG. 7 is a flowchart showing an operation of an identification information extracting portion;

FIG. 8 shows an example of a display on a missing page display screen when there is no missing page;

FIG. 9 shows a data example of the management information table storage portion when there is a missing page;

FIG. 10 shows an example of a display on the missing page display screen when there is a missing page;

FIG. 11 shows an example of a display when a missing page is specified on the missing page display screen;

FIG. 12 shows a data example of the management information table storage portion when a missing page is supplemented;

FIG. 13 shows a data example of the management information table storage portion when all missing pages are not supplemented; and

FIG. 14 shows an example of a display on the missing page display screen when all missing pages are not supplemented.

### PREFERRED EMBODIMENTS OF THE INVENTION

Now, referring to the accompanying drawings, preferred embodiments according to the present invention will hereinafter be described.

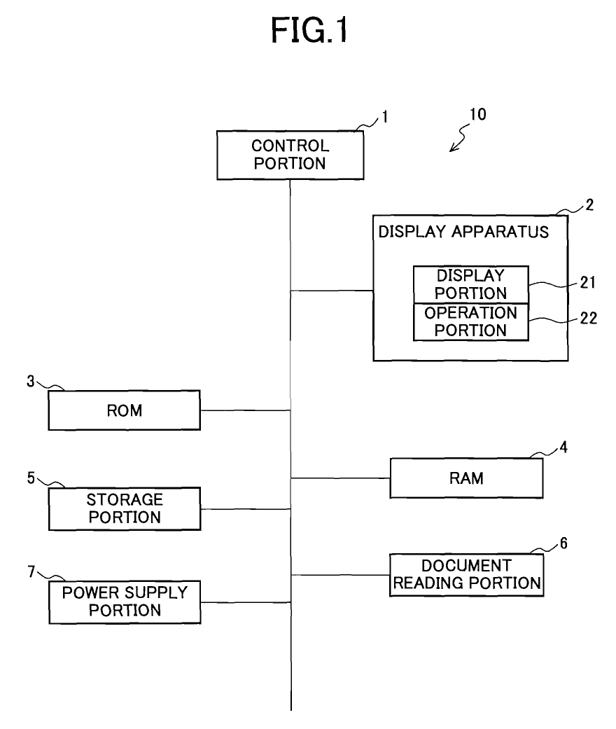

FIG. 1 is a block diagram showing the schematic structure of an image reading apparatus according to an embodiment of the present invention. Note that, the present invention is also applicable to a copier provided with an image reading apparatus, a facsimile apparatus, and a multifunctional peripheral.

In addition, on a document handled by the image reading apparatus, identification information for identifying each document is printed at a specific position in a margin of a document sheet in a form of a two-dimensional code (for example, a QR code (registered trademark)).

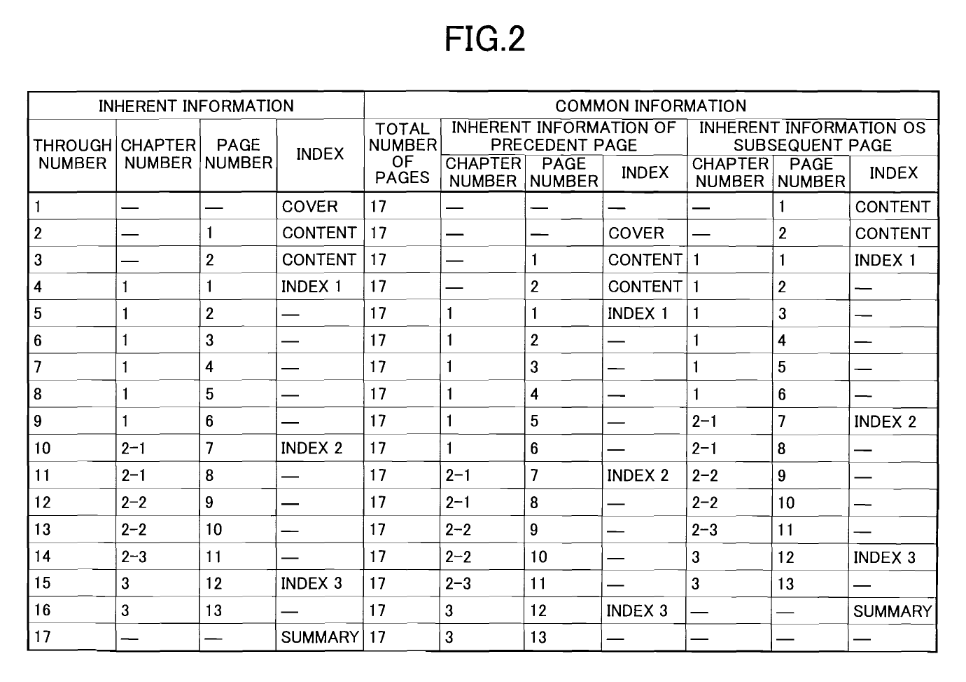

The identification information includes “specific information” and “common information” as illustrated in FIG. 2.

The “specific information” is constituted by “through number” which is given when documents are printed, “chapter number”, “page number” and “heading”, and the “common information” is constituted by “total number of pages” for recognizing association between pages and “specific information except for the through number of precedent and subsequent several pages”.

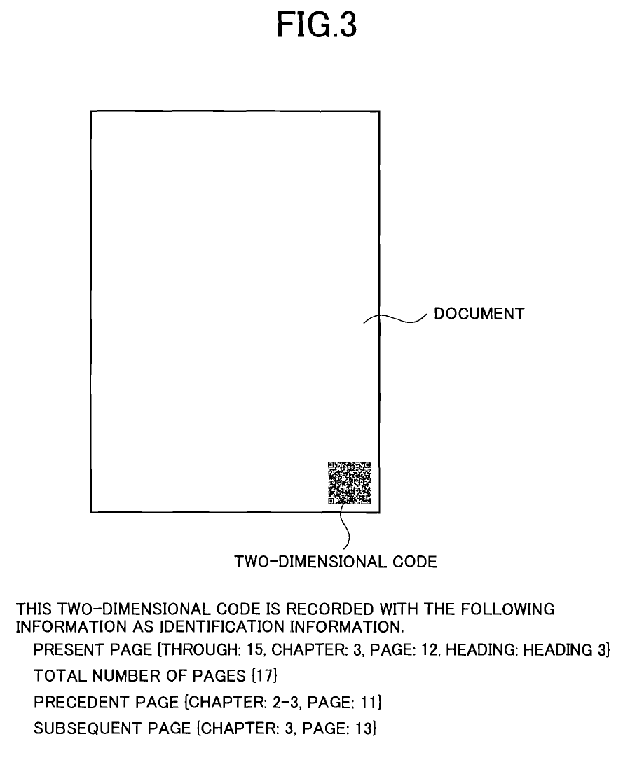

The identification information is printed by a two-dimensional code on a margin part or the like in the lower right side of a document, as shown in FIG. 3, but may be printed at any position capable of being identified.

In the figure, in the specific information, the character string of “the present page” showing a heading of the specific information is disposed, and, within “{ }”, the contents thereof including labels such as “through”, “chapter”, “page”, and “heading”, and a break symbol “:” are followed by data, like the present page {through: 15, chapter: 3, page: 12, heading: heading 3}.

Moreover, in “total number of pages” of the common information, the character string of “total number of pages” is disposed, which is followed by the total number of pages as the contents thereof within “{ }”, like total number of pages {17}.

In “specific information of precedent page” of the common information, the character string of precedent page is disposed, and, within “{ }”, the contents thereof including labels such as “chapter”, “page”, and “heading”, and a break symbol “:” are followed by data, like precedent page {chapter: 2-1, page: 7, heading: heading 2}.

Moreover, in “specific information of subsequent page” of the common information, the character string of “subsequent page” is disposed and, within “{ }”, the contents thereof including labels such as “chapter”, “page”, and “heading”, and a break symbol “:” are followed by data, like subsequent page {chapter: 1, page: 1, heading: heading 1}.

Among the specific information and the common information described above, as to a nonexistent label, the label and data will be omitted. In addition, in the present embodiment, specific information of each one page before and after a certain page is contained in common information as related information, but specific information of a plurality of pages before and after a certain page may be related information.

In this way, when code information is used as identification information, it is possible that identification information is easily extracted and recognized to prevent decrease in a processing speed and to reduce the load on the image reading apparatus.

In FIG. 1, an image reading apparatus 10 is constituted by including a control portion 1, a display apparatus 2, a ROM (Read Only Memory) 3, a RAM (Random Access Memory) 4, a storage portion 5, a document reading portion 6, and a power source portion 7.

The control portion 1 executes a control program stored in the ROM (Read Only Memory) 3 by a CPU (Central Processing Unit) or an MPU (Micro Processing Unit) to control the entire operation of the image reading apparatus 10.

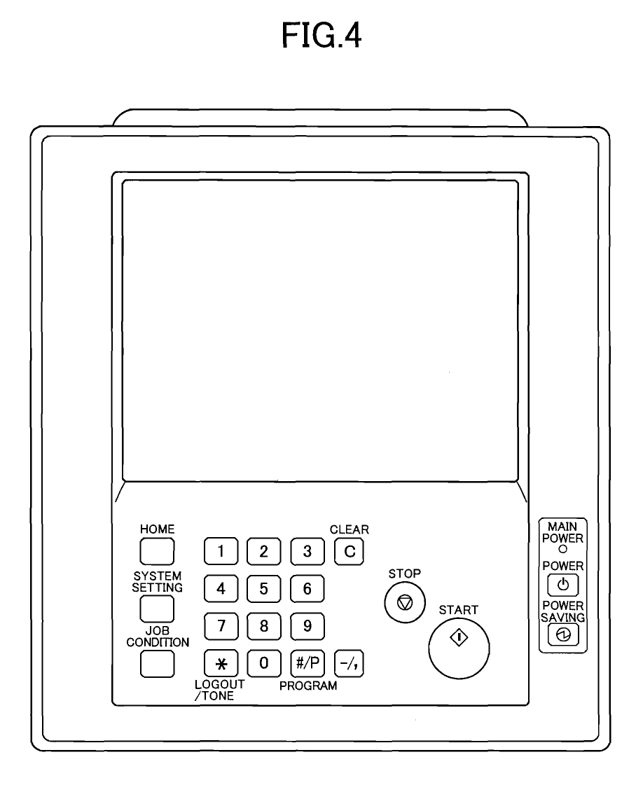

The display apparatus 2 is constituted by a display portion 21 and an operation portion 22 (FIG. 4).

The display portion 21 is constituted by a touch panel display on which, for example, in addition to a specification screen about various kinds of functions and a setting screen, operational states of the image reading apparatus 10, various kinds of messages, and the like are displayed.

Moreover, the operation portion 22 is constituted by various kinds of operation keys or switches, and a touch panel. By operating the touch panel, various kinds of operation keys or switches, a user is capable of specifying setting about image reading and execution of reading.

The ROM 3 is a memory for storing a control program that controls a whole of the image reading apparatus 10.

The RAM (Random Access Memory) 4 is a work memory used when the control program is in execution.

The storage portion 5 is constituted by, for example, a large-capacity nonvolatile storage apparatus such as a hard disc, in which image data of a document read by the document reading portion 6, various kinds of setting information, management data, and the like are stored.

The document reading portion 6 separates documents one by one from a document bundle placed on a document table to scan by a scanner and obtain as image data.

The power source portion 7 supplies electricity to the image reading apparatus 10.

Next, an operation of the present invention will be described.

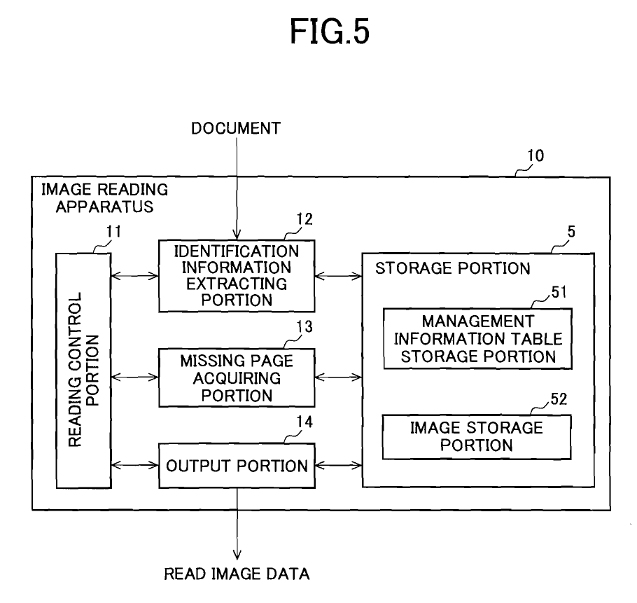

FIG. 5 is a block diagram showing the control structure of an image reading apparatus according to an embodiment of the present invention, where the image reading apparatus 10 is constituted by including a reading control portion 11, an identification information extracting portion 12, a missing page acquiring portion 13, and an output portion 14.

In addition, the storage portion 5 secures areas of a management information table storage portion 51 and an image storage portion 52.

The reading control portion 11 controls the identification information extracting portion 12 for reading a document to extract identification information, the missing page acquiring portion 13 for detecting and presenting a missing page from read documents to supplement the missing page from a document bundle read again, and the output portion 14 for outputting image data of the document whose missing page is supplemented, so as to control a document reading function in the present embodiment.

Processing of extracting identification information in the present embodiment is performed in the order of (1) extraction of an image of a two-dimensional code and (2) extraction of identification information, as described below.

### (1) Extraction of an Image of a Two-Dimensional Code

In an image of a two-dimensional code included in read image data, for example, when an existence position of the two-dimensional code is determined in advance, a position coordinate of a rectangle surrounding the image of the two-dimensional code at the position is determined and extracted. In addition, even when an existence position of the image of the two-dimensional code is not determined on a document, it is possible to extract by determining a position coordinate of a rectangle surrounding the image of the two-dimensional code with a known technology.

### (2) Extraction of Identification Information

The image of the two-dimensional code in the determined rectangle is decoded in accordance with predetermined code decoding algorithm to obtain decoded contents from the two-dimensional code.

Next, from the decoded contents, for each specific information and common information, based on labels as described above, data of a through number, a chapter number, a page number, a heading, and the like corresponding to each label is extracted. Here, when any of the labels and data is not existent, the label is dealt with a value of no data.

Then, as processing result, the following two kinds of information are output.

### (A) Existence of Identification Information:

When no two-dimensional code exists, or when a two-dimensional code exists but no corresponding label exists, information showing that no identification information exists is output.

Alternatively, when a two-dimensional code exists and at least one corresponding label exists, information showing that identification information exists is output.

### (B) Output of Identification Information:

When at least one label corresponding to identification information exists, each label and data corresponding thereto are output for each specific information and common information.

Next, description will be given for read image data handled in the present embodiment and management information showing anteroposterior relation thereof.

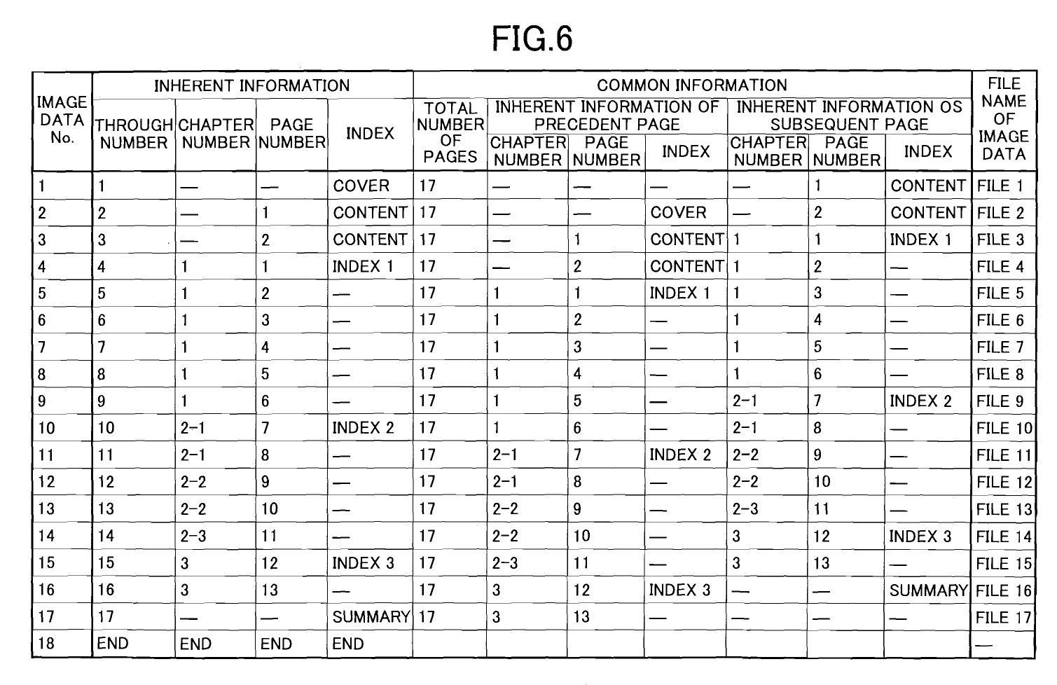

The management information table storage portion 51 stores the data structure having the following data items for each image data read from a document (FIG. 6), and the image storage portion 52 stores a data file for storing the image data read from the document.

Image data number (No.): A counter value of image data added in the order of reading.

Through number: A consecutive number of pages added when printing documents.

Chapter number: A chapter number of each page. The chapter number may be in an arbitrary form including a section number.

Page number: A consecutive number of each page. The page number is added arbitrarily and, for example, may be added for the entire document or for each chapter.

Heading: Showing kinds of each page, including “cover”, “contents”, “heading number”, “summary”, and “back cover”. Among them, the heading may be added with numbers (for example, “1”, “10”, and the like) in the order that a heading appears, or may be a title added to a chapter or a section.

In addition, to a document in which no identification information exists, the “heading” is added in a form different from a document in which identification information exists. The heading at this time is, for example, in a form that subsequent to the character string of “inserting page”, a counter value that is added in the order that a document in which no identification information exists appears is combined thereto.

File name of image data: A name of a data file in which image data of each page is stored. The data file is added with a file name which is exclusive in the image storage portion 52 to be stored in the image storage portion 52.

In FIG. 6, in data items of a chapter number, a page number and a heading, one indicated by “-” shows that there is no description in specific information.

In addition, in data items of a chapter number, a page number and a heading, one indicated by “END” shows that there is not corresponding image data, that is, the total number of pages of a document is 17 pages.

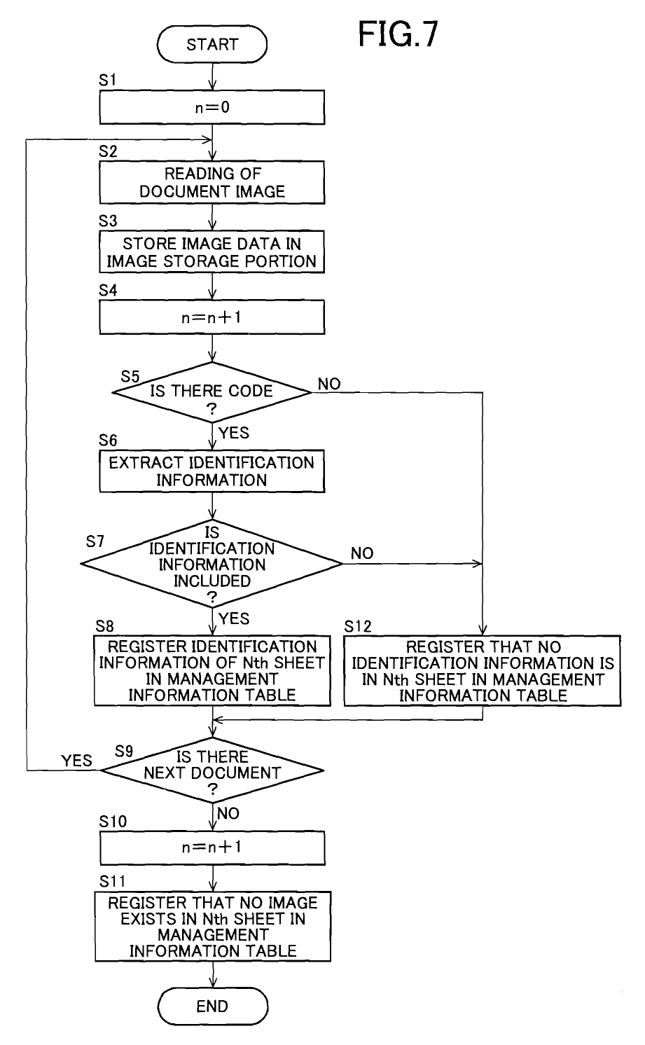

Next, an operation of the identification information extracting portion 12 will be described using the flowchart of FIG. 7.

When a user sets a document bundle on a document table and operates the operation portion 22 so that the reading control portion 11 captures an instruction of reading, the identification information extracting portion 12 is activated.

The identification information extracting portion 12 clears a page counter n for counting the number of documents into zero (step S1), and reads the documents while sequentially feeding the documents by the document reading portion 6 (step S2). Here, when an instruction of double-sided reading is given by the user, images on the front and rear sides of the documents are treated as separate images.

Read image data is sequentially added with a file name exclusive in the image storage portion 52 to be stored (step S3), and the page counter n is counted up to manage the number of reading (step S4).

Next, whether or not a two-dimensional code exists in the read image data is analyzed, and when no two-dimensional code exists (in the case of NO at step S5), the procedure proceeds to step S12.

Alternatively, when a two-dimensional code exists (in the case of YES at step S5), identification information is extracted from the two-dimensional code (step S6), and when no identification information is included (in the case of NO at step S7), and the procedure proceeds to step S12.

Alternatively, when identification information is included in the two-dimensional code (in the case of YES at step S7), a value of the page counter n as an image data number, the extracted identification information (specific information and common information), a name of file in which the read image data is stored are newly registered in the management information table storage portion 51 (step S7), and the procedure proceeds to step S9.

Among the specific information, when any of a chapter number, a page number and a heading is not included in the identification information, the values thereof are registered as values of nonexistence.

On the other hand, when no two-dimensional code exists (in the case of NO at step S5), and when no identification information exists (in the case of NO at step S7), a value of the page counter n as an image data number, the generated identification information, a name of a file in which the read image data is stored are newly registered in the management information table storage portion 51 (step S12), and the procedure proceeds to step S9.

Here, in each item of the specific information among the above-described generated identification information, a value of nonexistence for the chapter number, a value of nonexistence for the page number, a heading generated from the consecutive number added in the order that the document in which no identification information exists appears (“inserting page number”) for the heading are set, respectively. In addition, in all items of the common information, a value of nonexistence is set.

When existence of a next document to be read is confirmed and there is a document to be read (in the case of YES at step S9), the procedure returns to step S2 to continue reading of the next document.

Then, when there is no document to be read (in the case of NO at step S9), the page counter n is counted up (step S10) and information showing that no image exists in the n-th sheet (“END”) is registered in the management information table storage portion 51 (step S11) to complete the processing.

In this way, when reading of all documents is completed, in the example of FIG. 6, information of 17 pages of the document is stored in the management information table storage portion 51.

For example, in a document whose image data number is “2”, as specific information, a through number of “2” and a heading of “contents” are extracted, and among common information, “17” of a total number of pages, a heading of “cover” as specific information of a precedent page, and a page number of “2” and a heading of contents as specific information of a subsequent page are extracted, respectively, which shows that image data of the cover is written in a data file having a name of “file 2”.

In addition, in a document whose image data number is “10”, as specific information, a through number of “10”, a chapter number of “2-1”, a page number of “7”, and a heading of “heading 2” are extracted, and among common information “17” of a total number of pages, and a chapter number of “1” and a page number of “6” as specific information of a precedent page, and a chapter number of “2-1” and a page number of “8” as specific information of a subsequent page are extracted, respectively, which shows that image data of the page is written in a data file having a name of “file 10”.

Next, when reading of all documents is completed, the reading control portion 11 activates the missing page acquiring portion 13.

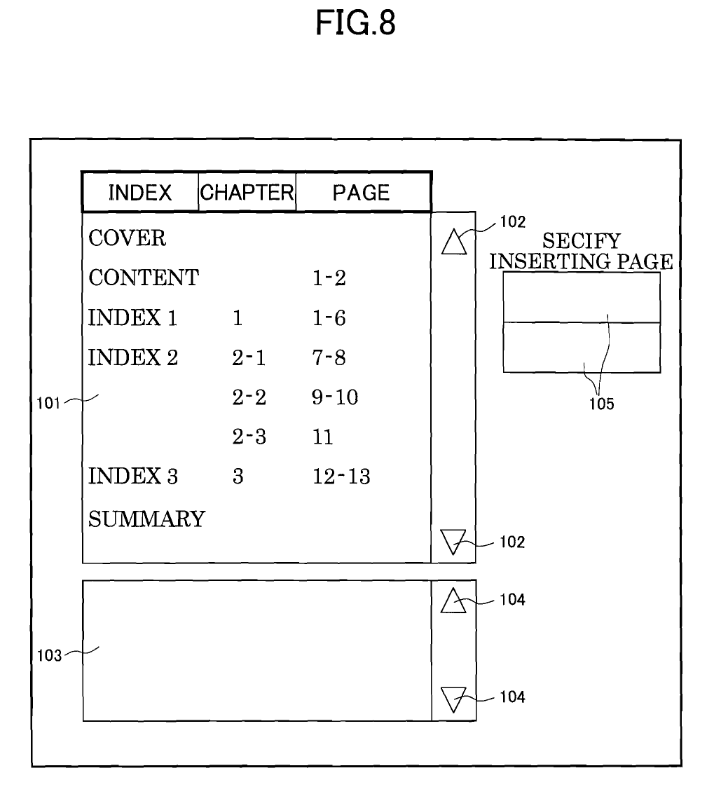

Upon activation, the missing page acquiring portion 13 refers to identification information stored in the management information table storage portion 51 to rearrange each image data in order of through number so that a heading, a chapter number, and a page number of specific information of each image data are displayed on the missing page display screen in the form as illustrated in FIG. 8.

FIG. 8 shows an example of a missing page display screen when there is no missing page when documents are read like in FIG. 6.

101 denotes a display of the detailed structure of specific information added to read image data, which is displayed being classified into each item of “heading”, “chapter number”, and “page number”. In addition, each item is selectable by touching.

102 denotes a scroll button for scrolling a display item up and down when items displayed in the area 101 can not be displayed.

103 denotes an area for display when there is a missing page, which is constituted by the same items as the area 101, and each item is selectable by touching.

104 denotes a scroll button for scrolling a display item up and down when items displayed in the area 103 can not be displayed.

105 denotes an area in which a page number of an inserting page is specified by a user when there is a missing page when documents are read.

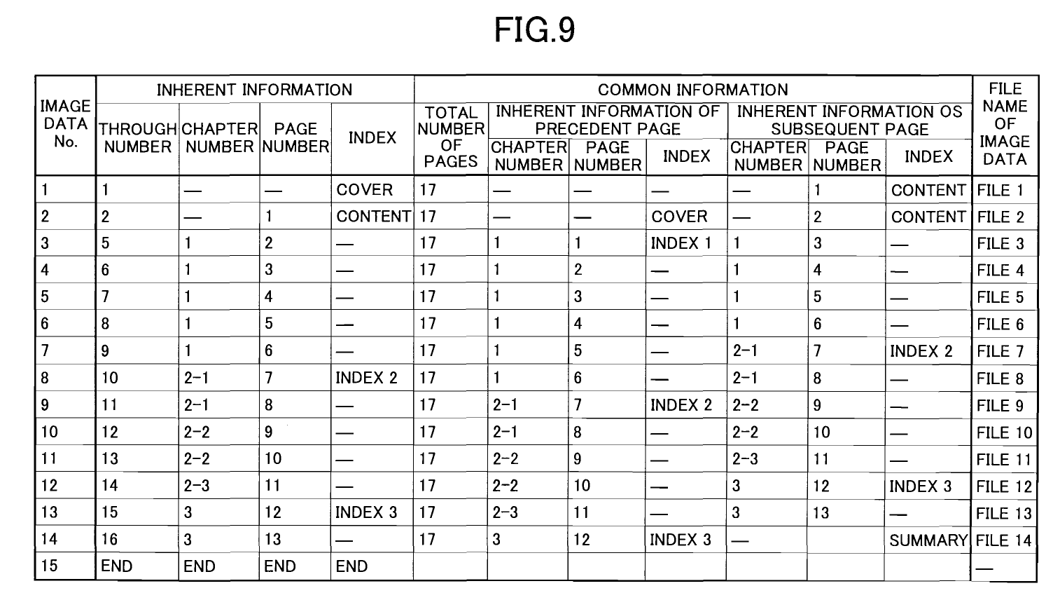

Moreover, as shown in FIG. 9, when there is a missing page in read image data, the missing page acquiring portion 13 detects that through numbers 3, 4, and 17 are lacking based on continuity of through numbers and a total number of pages, to acquire specific information of the through numbers from common information.

For example, specific information of the through number 3 is acquired from specific information of a page subsequent to the through number 2, specific information of the through number 4 is acquired from specific information of a page precedent to the through number 5, and specific information of the through number 17 is acquired from specific information of a page subsequent to the through number 16.

In this case, when three or more missing pages continue, it is impossible to acquire specific information of the missing pages. However, when specific information of precedent and subsequent two or more pages is provided as common information, it is possible to acquire.

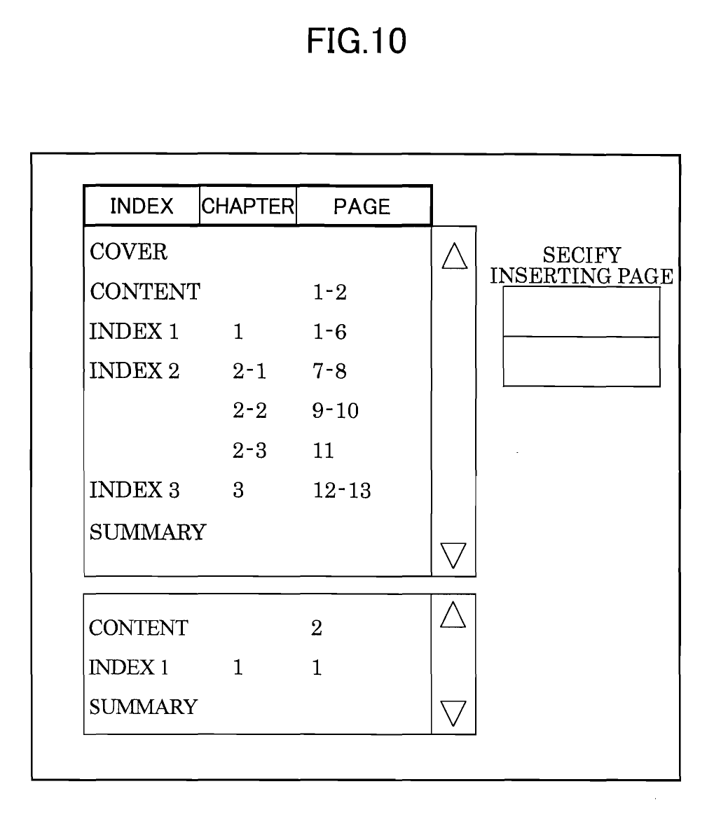

Then, the missing page acquiring portion 13 displays a heading, a chapter number, and a page number of the missing pages obtained as described above on the missing page display screen as shown in FIG. 10.

Next, an instruction to acquire a missing page will be described using the missing page display screen.

A user touches the area 103 on the missing page display screen of FIG. 10.

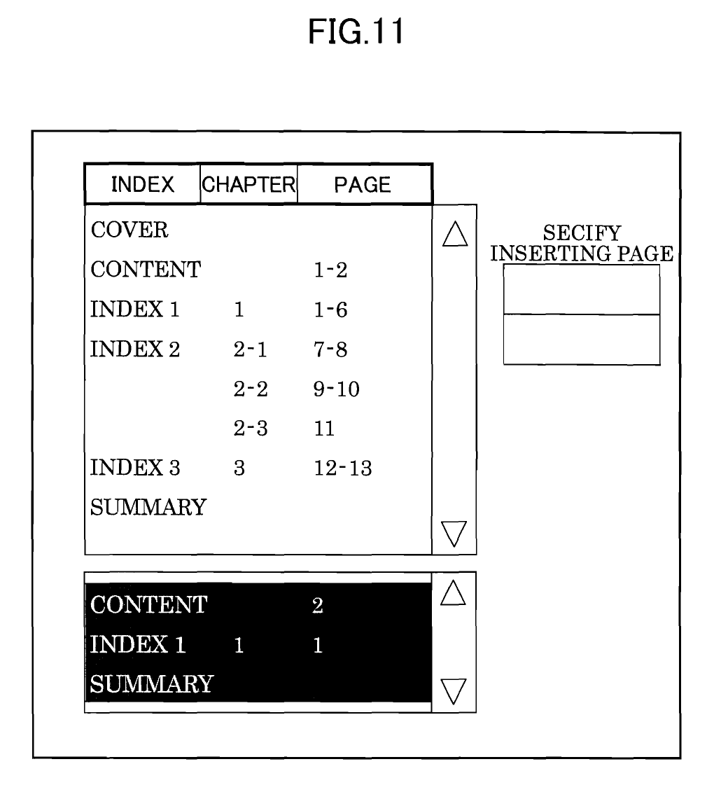

When detecting that the area 103 is touched, the missing page acquiring portion 13 reversely displays a missing page displayed in the area 103 (FIG. 11) and waits for detection of an instruction to read a document bundle (pressing of a start key).

The user presses the start key after placing the document bundle once read again.

When detecting the instruction to read the document (pressing of a start key), the missing page acquiring portion 13 starts reading of the document bundle and repeats the following processing every time one sheet of documents is read.

(1) Extract identification information added to image data of the read document to check whether or not specific information in the extracted identification information is the same as specific information of a missing page.
(2) When both specific information is not the same, read a next document.
(3) However, when both specific information is the same, the image data of the read document is stored in the image storage portion 52 as a data file with an exclusive file name.
(4) Register next data newly in the management information table storage portion 51.

The newly registered data includes a page counter n of the image data, identification information extracted from the image data of the read document, and the file name.

(5) Count up the page counter n of the image data to update data showing the end of the image data in the management information table storage portion 51.
(6) Delete from a list of missing pages displayed in the area 103 on the missing page display screen to update the display.

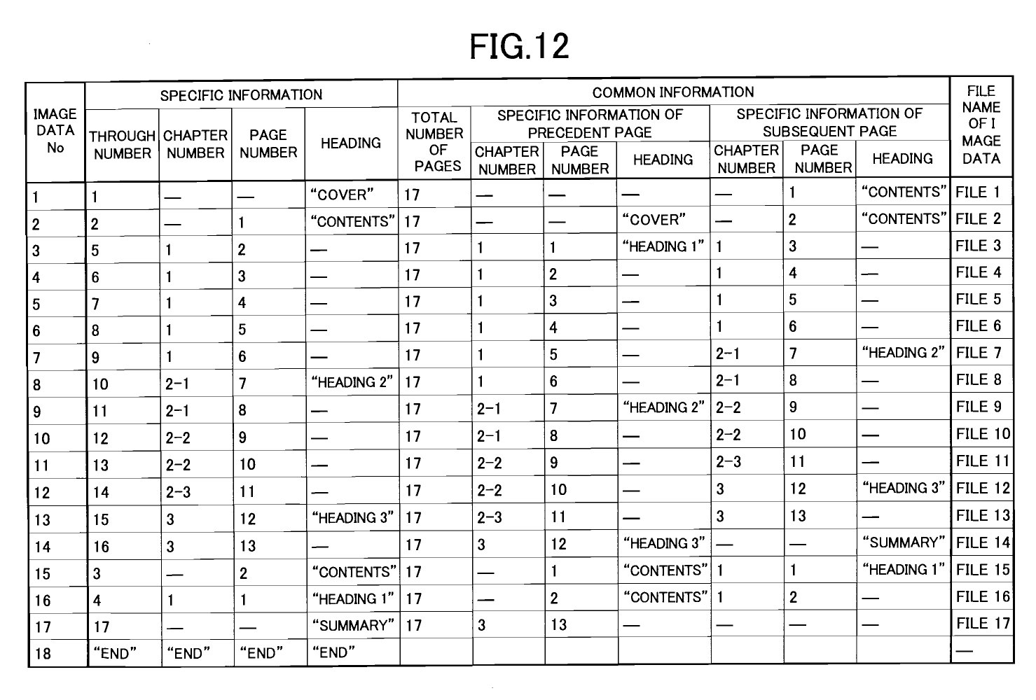

When reading of all documents is completed in this way and documents corresponding to all missing pages are read, the management information table storage portion 51 is updated as shown in FIG. 12 and the missing page display screen is displayed as shown in FIG. 8.

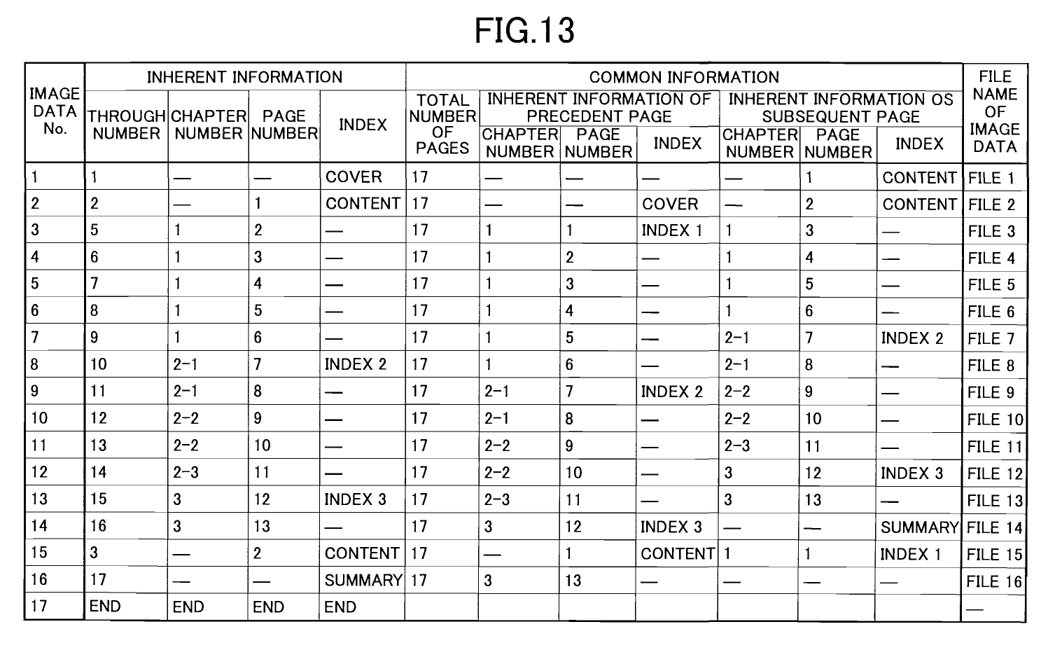

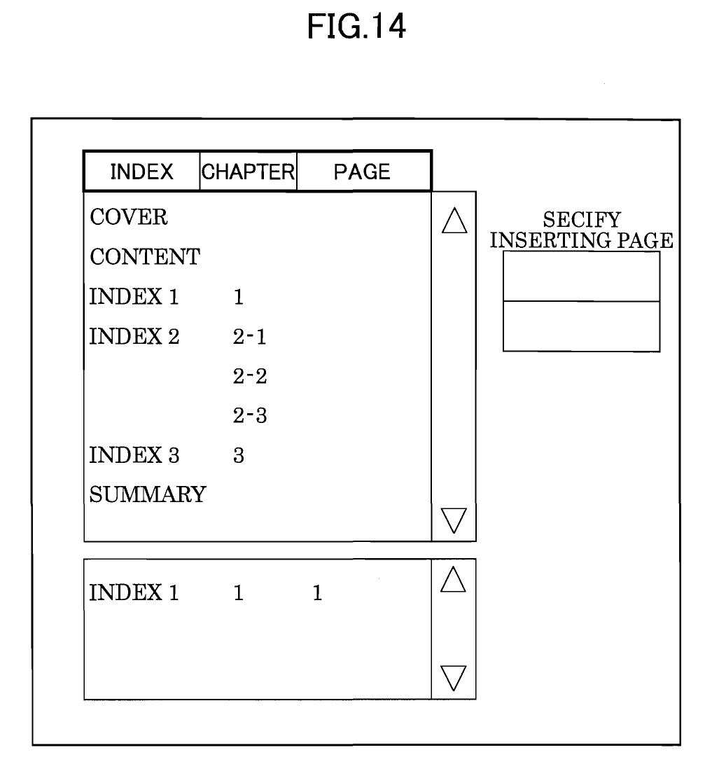

However, three pages of missing pages of through numbers 3, 4, and 17, should have been supplemented by the above-described operation, but when the document of “heading 1” (through number 4) can not be read again due to double feeding, the management information table storage portion 51 is updated as shown in FIG. 13 and the missing page display screen is displayed as shown in FIG. 14.

In this case, by touching “heading 1” of the missing page displayed in the area 103 of FIG. 14 to read the document bundle again, it is possible to supplement the missing page.

As described above, when supplement of the missing page is completed, the user gives an instruction to complete reading by the operation portion 22.

When detecting completion of reading, the reading control portion 11 completes execution of the missing page acquiring portion 13 to active the output portion 14.

The output portion 14 refers to specific information and common information of each image data stored in the management information table storage portion 51 to rearrange in order of through number so as to output the image data taken from the image storage portion 52 in this order to the outside of the image reading apparatus 10.

Note that, at the time of outputting, an unnecessary two-dimensional code may be deleted. The deletion of an image of a two-dimensional code is performed, for example, by a method that an average density value of pixels existing around a dark section in an image of the two-dimensional code (an area where a graphic pattern exists) (that is, a background part) is replaced with an pixel value of the dark section.

By configuring the present embodiment as described above, it is possible to perform supplement for a missing page detected at the time of reading of documents and to reduce a work burden on a user.

In addition, when a two-dimensional code printed on a document is deleted, it is possible to prevent deterioration in appearance.

Note that, in the identification information extracting portion 12 in the above-described embodiment, identification information is extracted every time a sheet of documents is read, but identification information may be extracted from image data of read documents after reading all documents.

In this case, while reading all documents, a file name of a data file that image data of the read documents is written in the image storage portion 52 and an image data number are registered in the management information table storage portion 51. Then, after completion of reading of the documents, update is made for identification information extracted from each image data.

Moreover, in the above-described embodiment, although description has been given assuming that identification information is formed as a two-dimensional code to be printed on a document, it is also possible to apply similarly when using an RFID (Radio Frequency-Identification) tag.

In this case, the RFID tag is embedded at a predetermined position of recording paper for a document (for example, in a margin part in top, bottom, left, or right side of the recording sheet) and identification information (specific information and common information) is written so as to be capable of being taken out in creating the document, and the identification information extracting portion 12 reads the contents of the RFID tag by an RFID reader to extract the identification information.

According to the structure, it is possible to acquire identification information at a high speed as well as it is not necessary to perform processing of deleting identification information.

The present invention will not be limited to the above-described embodiments, and various modifications and alterations may be certainly made within the scope of the present invention. For example, programs to function a computer (the above-described control programs) are created as each portion of the image reading apparatus constituting the above-described embodiments to be written in a recording medium in advance, and the programs recorded in the recording medium are stored in a memory of the apparatus or a recording apparatus to execute the programs, whereby the object of the present invention is obviously attained.

In this case, the programs themselves read from the recording medium realize a function of the above-described embodiments, and therefore the programs and the recording medium having the programs recorded thereon will also constitute the present invention.

In addition, the programs are also included when the function of the above-described embodiments is realized by processing in combination with an operating system, other application programs, or the like, based on an instruction from the programs.

According to the present invention, it is possible to reduce a work burden on a user to detect a missing page when a plurality of sheets of a document are read continuously and supplement the missing page.

1. An image reading apparatus that continuously reads image data of a plurality of pages of a document, each page being added with identification information including specific information of the page and common information showing relationship with at least one precedent and one subsequent pages, comprising:
an image storage potion for storing image data of each page of the read document;
an identification information extracting portion for extracting the identification information from the image data;
a missing page detecting portion for detecting a page missed by failure of reading in the document based on identification information of each extracted page; and
a display portion for prompting reading of the document by displaying the missing page, wherein
when an instruction of rereading is given and identification information of the missing page is extracted from image data read again, the image data is additionally stored in the image storage portion.

2. The image reading apparatus as defined in claim 1, wherein
the identification information includes heading information and a page number.

3. The image reading apparatus as defined in claim 1, wherein
the identification information is formed with code information.

4. A method for reading an image used in an image reading apparatus that continuously reads image data of a plurality of pages of a document, each page being added with identification information including specific information of the page and common information showing relationship with at least one precedent and one subsequent pages, and stores image data of each page of the read document in an image storage portion, comprising:
an identification information extraction step of extracting the identification information from image data of each page of the read document;
a missing page detection step of detecting a page missed by failure of reading in the document based on identification information of each extracted page; and
a display step of prompting reading of the document by displaying the missing page, wherein
when an instruction of rereading is given and identification information of the missing page is extracted from image data read again, the image data is additionally stored in the image storage portion.

5. An image forming apparatus comprising the image reading apparatus as defined in any one of claims 1 to 3.

6. A program that causes a computer to function as each portion of the image reading apparatus as defined in any one of claims 1 to 3.
